(19) United States
(12) Patent Application Publication
(10) Pub. No.: US 2009/0100081 A1
(43) Pub. Date: Apr. 16, 2009

(54) INFORMATION PROCESSING APPARATUS, INFORMATION PROCESSING METHOD, AND PROGRAM STORAGE MEDIUM STORING PROGRAM

(75) Inventor: Kazuyuki SHIBUYA, Kanagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/247,353

(22) Filed: Oct. 8, 2008

(30) Foreign Application Priority Data
Oct. 12, 2007 (JP) 2007-266932

(51) Int. Cl. G06F 17/30

(52) U.S. Cl. 707/100; 707/E17.044

(57) ABSTRACT

The present invention provides an information processing apparatus that replicates and stores content data stored in an external device, the information processing apparatus comprising: a content data storing section that stores first content data; a metadata storing section that stores first metadata of the first content data; a content data detecting section that detects whether second content data with the same content as the first content data is stored in the external device; a comparison section that compares second metadata of the second content data and the first metadata when the second content data is detected; an instruction inputting section that causes an operator to input an instruction related to a changing process of the first metadata when the first metadata and the second metadata are different; and a metadata changing section that changes the first metadata based on the instruction of the operator.

### CROSS REFERENCE TO RELATED APPLICATION

This application claims benefit of Japanese Application No. 2007-266932 filed on Oct. 12, 2007 the contents of which are incorporated by this reference.

### BACKGROUND OF THE INVENTION

1. Field of the Invention

The present invention relates to an information processing apparatus that stores and manages content data, an information processing method and a program storage medium storing a program.

2. Description of the Related Art

Conventionally, as shown in Japanese Patent Application Laid-Open Publication No. 2003-333472, a method has been proposed in which a control list is created at a predetermined location separate from content files and utilized, the content files being stored in a predetermined location in a storage medium. A similar technology called MPV that is a standard established by an industry group of optical disk OSTA in 2002 has also been disclosed. In the document and the technology, information related to the content such as file name of content file, file path, content creation date, and title (hereinafter, the information will be called metadata) is listed and then collectively described in a control list file. This allows easy search and management of content, efficient edit processing, and high-speed processing.

Furthermore, as shown in Japanese Patent Application Laid-Open Publication No. 2003-296162, upon copying of the content between storing/reproducing devices, file names of the content and the content of the files are compared, copying is not performed depending on the comparison result, the operator is asked to change a file name, or the file name is changed under a certain rule in the device without questioning the operator. This allows efficient file management.

### SUMMARY OF THE INVENTION

The present invention provides an information processing apparatus that replicates and stores content data stored in an external device, the information processing apparatus comprising: a content data storing section that stores first content data; a metadata storing section that stores first metadata related to the first content data; a content data detecting section that detects whether second content data that is the same content data as the first content data is stored in the external device; a comparison section that compares second metadata related to the second content data stored in the external device and the first metadata when the content data detecting section detects that the second content data is stored in the external device; an instruction inputting section that causes an operator to input an instruction related to a changing process of the first metadata when the first metadata and the second metadata are different based on a comparison result of the comparison section; and a metadata changing section that changes the first metadata based on the instruction of the operator inputted through the instruction inputting section.

The above and other objects, features and advantages of the invention will become more clearly understood from the following description referring to the accompanying drawings.

### BRIEF DESCRIPTION OF THE DRAWINGS

FIG. 1 is an explanatory view of a schematic configuration of a digital still camera (DSC) according to an embodiment;

FIG. 2 is an explanatory view of an example of a folder configuration formed of content and a control list stored in an image storing section of the DSC;

FIG. 3 depicts an example of the content of the control list;

FIG. 4 is an explanatory view of a storing section of an external storing/reproducing device, a folder configuration of the storing section, and the content of a control list;

FIG. 5 is an explanatory view of an image storing section of the DSC, a folder configuration of the image storing section, and the content of a control list;

FIG. 6 is a flow chart of a difference copy process from the external storing/reproducing device to the DSC;

FIG. 7 is a flow chart of the difference copy process from the external storing/reproducing device to the DSC;

FIG. 8 is a flow chart of a metadata changing process in the difference copy process;

FIG. 9 is a flow chart of an operator instruction inputting process;

FIG. 10 is a flow chart of a metadata overwriting process;

FIG. 11 is a flow chart of a metadata parallel description process;

FIG. 12 is an explanatory view of the image storing section of the DSC, the folder configuration, and the content of the control list after performing the difference copy process;

FIG. 13 depicts an operator input screen;

FIG. 14 is an explanatory view of the image storing section of the DSC, the folder configuration, and the content of the control list after the difference copy process when an operator has instructed to overwrite with metadata of a copy source;

FIG. 15 is a flow chart of a modified example of the metadata parallel description process;

FIG. 16 is an explanatory view of the image storing section of the DSC, the folder configuration, and the content of the control list after performing the difference copy process using the modified example of the metadata parallel description process;

FIG. 17 is a flow chart of another modified example of the metadata parallel description process;

FIG. 18 is an explanatory view of the image storing section of the DSC, the folder configuration, and the content of the control list after performing the difference copy process using the another modified example of the metadata parallel description process;

FIG. 19 is a flow chart of still another modified example of the metadata parallel description process;

FIG. 20 depicts a control list stored in the storing section of the external storing/reproducing device;

FIG. 21 depicts a control list stored in the image storing section of the DSC; and

FIG. 22 depicts the control list of the DSC after performing the still another modified example of the metadata parallel description process.

### DETAILED DESCRIPTION OF THE PREFERRED EMBODIMENTS

An embodiment of the present invention will be described mainly using a digital still camera as an example of an information processing apparatus and mainly using a still image as an example of content data (content).

The embodiment of the present invention will be described.

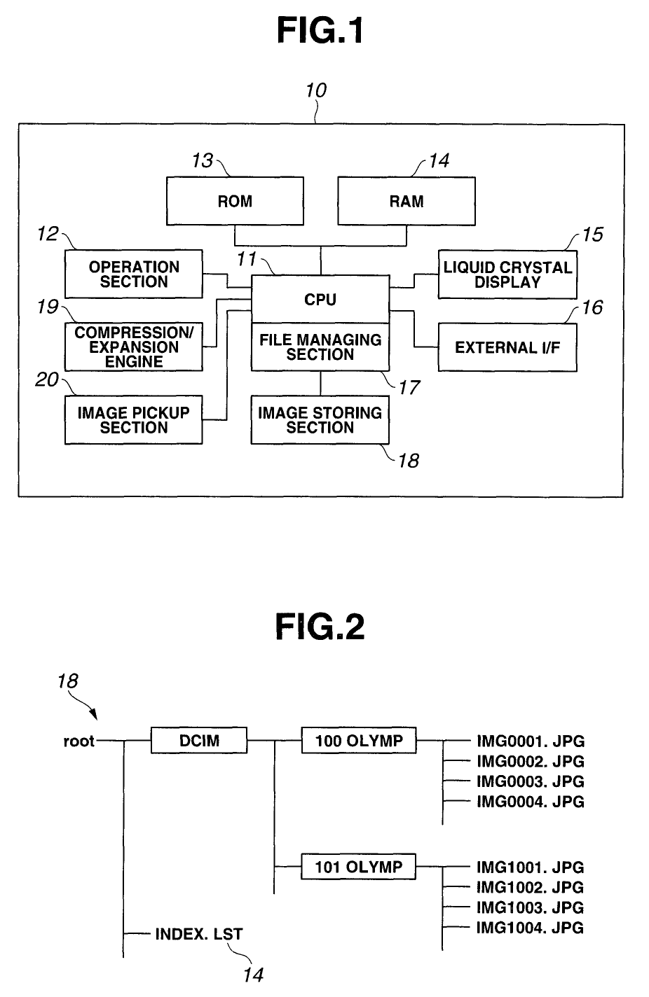

As shown in FIG. 1, a digital still camera (hereinafter called “DSC”) 10 as an information processing apparatus of the present embodiment includes a CPU 11, an operation section 12, a ROM 13, a RAM 14, a liquid crystal display 15, an external I/F 16, a file managing section 17, an image storing section 18, a compression/expansion engine 19, and an image pickup section 20. The operation of the DSC 10 is controlled by the CPU 11 that is operated in accordance with a program stored in the ROM 13 serving as a program storing storage medium.

The image storing section 18 constituting a first content data storing section and a metadata storing section is a semiconductor memory, a magnetic memory, a magnetic disk, an optical disk, or a magneto-optical disk, or any other storage medium capable of storing information.

The image storing section 18 stores content data such as image data and a control list described below. The image storing section 18 may be constituted by a plurality of storage media having the same or different storage formats.

One or a plurality of image data and control lists stored in the image storing section 18 are designed to be saved in an external storing/reproducing device (external device), which is an electronic device such as a personal computer not shown, through the external I/F 16 as a communication section based on an instruction from the operator transmitted through the operation section 12.

The communication between the DSC 10 and the external storing/reproducing device through the external I/F 16 is wired or wireless communication using, for example, a USB (Universal Serial Bus), a Wireless USB, or a wireless LAN.

The liquid crystal display 15 can display one or a plurality of image data stored in the image storing section 18. The liquid crystal display 15 does not have to be a liquid crystal display as long as it is a display device capable of reproducing contents. For example, a display device in another form can be used, such as an electrophoretic device like an EL (Electro-Luminescence) display and electronic paper.

FIG. 2 is an example of a folder configuration formed of content data, such as still images, motion pictures, and sound stored in the image storing section 18 of the DSC 10, and a control list file 40 (first control list). Hereinafter, the content data will be simply called “content”, and the control list file will be simply called “control list”.

The content in the present embodiment is stored in accordance with a DCF (Design rule for Camera File system) standard under a DCIM folder of the image storing section 18.

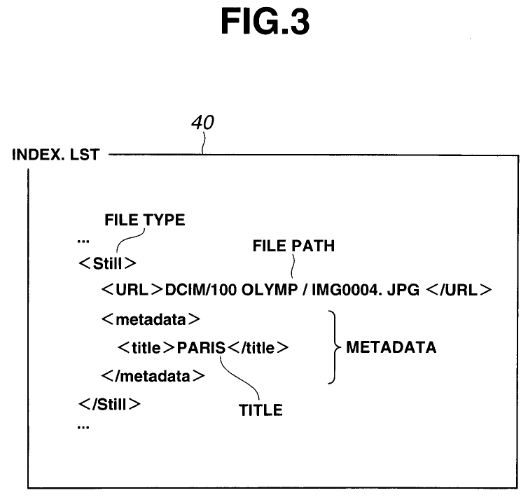

FIG. 3 is an example of the content of the control list 40. The control list 40 is described in accordance with, for example, an XML (Extensible Markup Language) format. File paths indicative of the locations of files in the content in the image storing section 18 and metadata related to the content such as a content creation date and a title are described in the control list 40. The file size of the control list 40 can be an arbitrary size. The metadata related to the content denotes data described with information concerning the content such as a creation date and time of the content, a title, a shooting condition such as shutter speed, and a shooting location.

The CPU 11, the RAM 14, the file managing section 17, the image storing section 18, the compression/expansion engine 19, and the image pickup section 20 constitute a storing section that stores contents using the control list 40 as content management information. The CPU 11, the liquid crystal display 15, the file managing section 17, the image storing section 18, and the compression/expansion engine 19 constitute a reproducing section that reproduces contents using the control list 40. The CPU 11, the file managing section 17, and the image storing section 18 constitute a control list updating section that changes the content of the control list. It is obvious that the configurations of the storing section, the reproducing section, and the control list updating section are not limited to the ones in the present embodiment as long as the configurations can achieve equivalent functions.

An operation of the reproduction by the DSC 10 will be described with reference to FIGS. 2 and 3. Upon the reproduction, the control list 40 (INDEX.LST) existing just below a root directory in the image storing section 18 is first referenced through the file managing section based on an instruction from the CPU 11.

A predetermined content is read based on one or a plurality of file paths of the content described in the control list 40, and the compression/expansion engine 19 expands and reproduces the predetermined content in accordance with a stored format. The reproduced content, for example, image data, is displayed on the liquid crystal display 15.

An operation of the DSC 10 upon shooting will be described with reference to FIGS. 2 and 3. Upon shooting, the compression/expansion engine 19 compresses the image pickup data in the RAM 14 imported from the image pickup section 20 into data (content) in a format designated by the CPU 11.

The content is stored in the image storing section 18 through the file managing section 17 by the instruction from the CPU 11. The CPU 11 opens the control list 40 (INDEX.LST) existing just below “root” in the image storing section 18. The CPU 11 appends metadata such as type of content, file path, and information related to the content to a predetermined location in the control list 40 and saves the control list 40.

An operation of transferring the content between the DSC 10 of the present embodiment and the external storing/reproducing device 30 as an external device will be described. As described, the external storing/reproducing device 30 is, for example, an electronic device such as a personal computer and includes a storing section 31 as a storage medium.

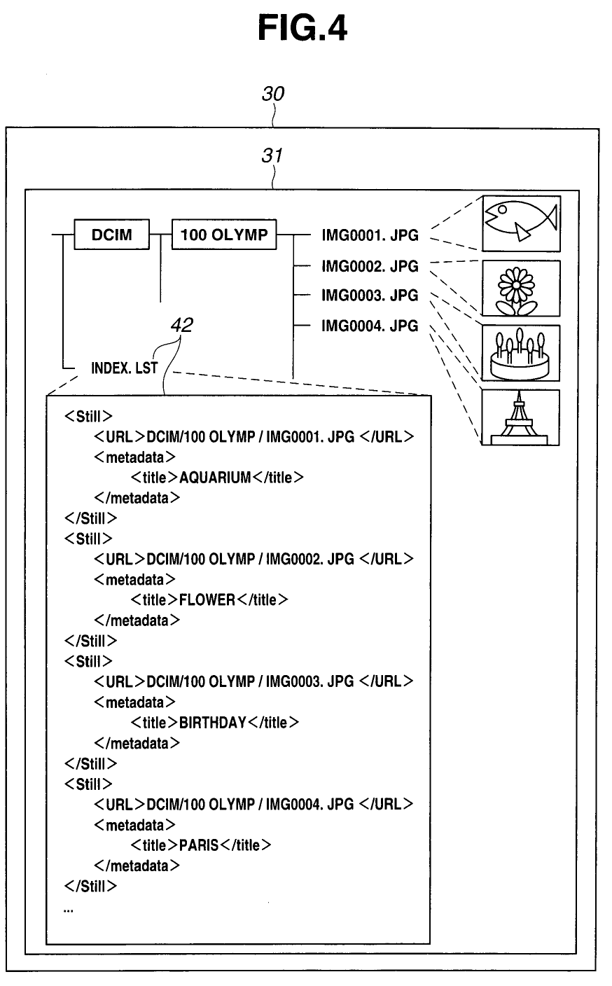

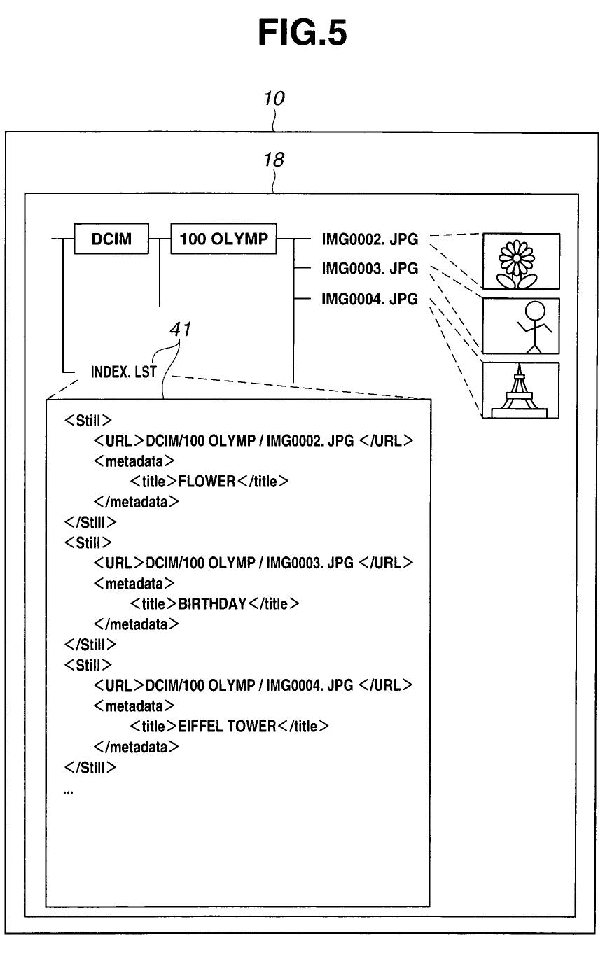

FIG. 4 depicts a configuration of a folder and content (second content) stored in the storing section 31 of the external storing/reproducing device 30 and the content of a control list 42 (second control list). FIG. 5 depicts a configuration of a folder and content (first content) stored in the image storing section 18 of the DSC 10 and the content of a control list 41 (first control list).

In the present embodiment, as shown in FIGS. 4 and 5, the image storing section 18 of the DSC 10 and the storing section 31 of the external storing/reproducing device 30 store contents called IMG0004.JPG that are images with the same file names and the same contents. The files IMG0004.JPG stored in both of the image storing section 18 of the DSC 10 and the storing section 31 of the external storing/reproducing device 30 include the same file paths.

A title “EIFFEL TOWER” as first metadata is provided to the file IMG0004.JPG in the control list 41 stored in the image storing section 18 of the DSC 10.

Meanwhile, a title “PARIS” as second metadata is provided to the file IMG0004.JPG in the control list 42 stored in the storing section 31 of the external storing/reproducing device 30.

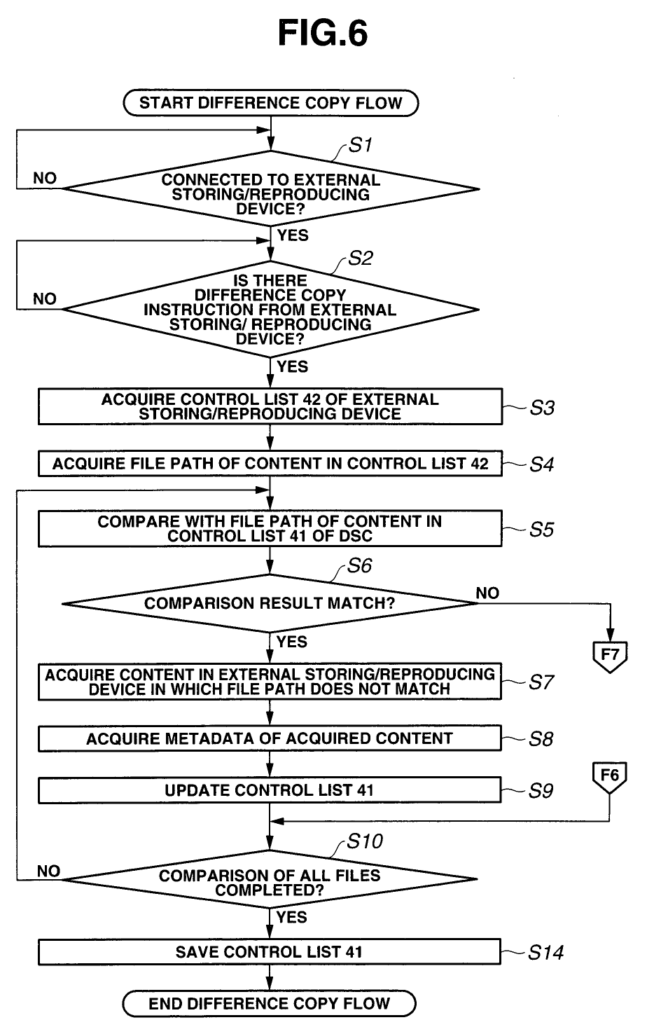

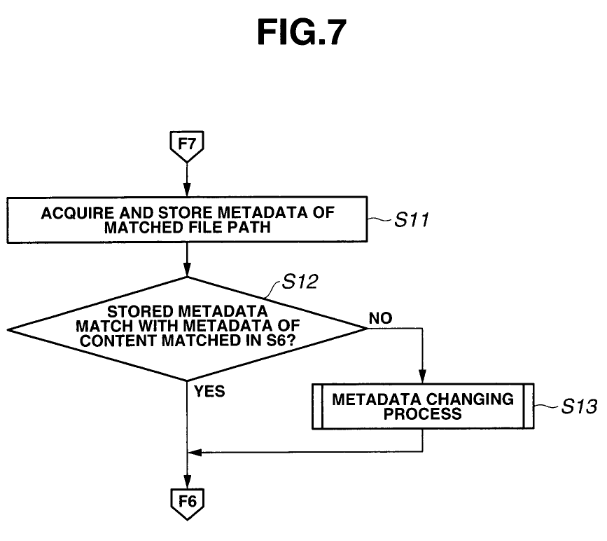

An operation of a difference copy process between the DSC 10 and the external storing/reproducing device 30 as an external device will be described with reference to flow charts shown in FIGS. 6 and 7.

The difference copy process herein denotes a process of comparing the control list 41 stored in the DSC 10 and the control list 42 stored in the external storing/reproducing device 30, and subsequent to the comparison, copying the content that is described in the control list 42 of the external storing/reproducing device 30 but that is not described in the control list 41 of the DSC 10 to the image storing section 18 of the DSC 10.

In other words, the difference copy process is a process of collectively copying only the contents that do not exist in the image storing section 18 of the DSC 10 but that exist in the storing section 31 of the external storing/reproducing device 30 to the DSC 10.

The difference copy process is started by a difference copy instruction from one of the DSC 10 and the external storing/reproducing device 30. In the present embodiment, the DSC 10 executes the difference copy process described below in accordance with an information processing program stored in the ROM 13 or the image storing section 18.

In step S1, whether the DSC 10 is communicably connected to the external storing/reproducing device 30 in a communication format of the external I/F 16 is determined. If the connection is not established, the process waits for the connection. If the connection is established, whether the difference copy instruction from the external storing/reproducing device 30 is inputted is determined in step S2. If there is no difference copy instruction, the process waits for the reception of the difference copy instruction.

If there is a difference copy instruction, the control list 42 (INDEX.LST) stored in the storing section 31 of the external storing/reproducing device 30 is acquired through the external I/F 16 in step S3, and the control list 42 is stored in the RAM 14.

In step S4, all file paths of the content described in the control list 42 stored in the RAM 14 are read and stored in the RAM 14. In other words, all file paths of the content stored in the storing section 31 of the external storing/reproducing device 30 are stored in the RAM 14 in step S4.

In step S5, one of the file paths stored in the RAM 14 in step S4 is extracted and compared with all file paths described in the control list 41 (INDEX.LST) stored in the image storing section 18 of the DSC 10.

In step S6, the comparison result is reviewed, and if the file path extracted in step 5 does not match with any of the file paths described in the control list 41, the process moves to step S7.

In step S7, the content in the external storing/reproducing device 30 corresponding to the file path that does not match is acquired through the external I/F 16 and stored in the image storing section 18. In step S8, the metadata of the content acquired in step S7 is acquired from the control list 42 in the RAM 14.

In step S9, the file paths extracted in step S4, the metadata acquired in step S8, and the like are appended to a predetermined location in the control list 41 of the DSC 10, and the content of the control list 41 is updated.

Thus, in step S9, the metadata of the content newly stored in the image storing section 18 of the DSC 10 by the difference copy process is appended to the control list 41.

In step S10, whether comparison of all file paths stored in the RAM 14 in step S4 is completed is determined. If the comparison is not completed, the process returns to step S5 and continues the comparison. If the comparison is completed, the difference copying is terminated. The control list 41 is saved in step S114, and the difference copy process ends.

Meanwhile, if the file path extracted in step S5 matches with any of the file paths described in the control list 41 in step S6, the process moves to step S11.

In step S11, the metadata provided to the content in the external storing/reproducing device 30 corresponding to the matched file path is acquired from the control list 42 stored in the RAM 14 in step S3, and the metadata is stored in the RAM 14.

In step S12, whether the metadata stored in step S11 matches with the metadata provided to the content indicated by the matched file path in the control list 41 is determined.

Thus, in step S12, whether the metadata of the contents with the same file names stored in the same file paths in the DSC 10 and the external storing/reproducing device 30 match is determined.

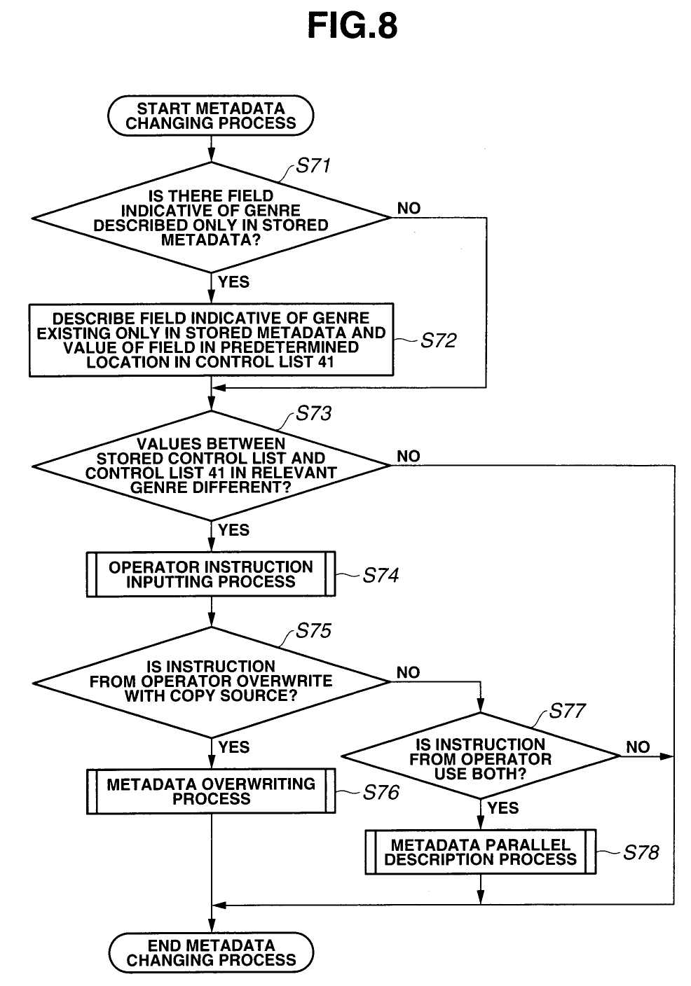

If the metadata are determined to match as a result of the comparison in step 12, the process proceeds to step S10. If the metadata are determined not to match, the metadata changing process shown in FIG. 8 is executed in step S113, and the process proceeds to step S10.

FIG. 8 is a flow chart of a metadata changing process in the difference copy process. In step S71 of the metadata changing process, the metadata extracted from the control list 42 and then stored in step S11 and the metadata provided to predetermined content in the control list 41 are compared, and whether there is a field indicative of a genre that is described only in the metadata stored in step S11 and that is not described in the metadata of the predetermined content in the control list 41 is determined. The genre herein denotes a type of metadata such as a title and a creation date.

Thus, in step S71, whether there is a field only described in the metadata of the content stored in the external storing/reproducing device 30 among the metadata of the contents with the same file names stored with the same file paths in both of the DSC 10 and the external storing/reproducing device 30 is determined.

If there is a field described only in the metadata stored in step S11 as a result of the determination in step S71, the field described only in the stored metadata and a value of the field are described in a predetermined location in the control list 41 in step S72.

Meanwhile, if there is no field described only in the metadata stored in step S11 as a result of the determination in step S71, the process skips step S72 and moves to step S73.

In step S73, whether the values of the genres of the metadata are different between the stored control list 42 and the control list 41 is determined. If the values are the same between the stored control list and the control list 41 as a result of the determination in step S73, nothing is performed, and the metadata changing process is terminated.

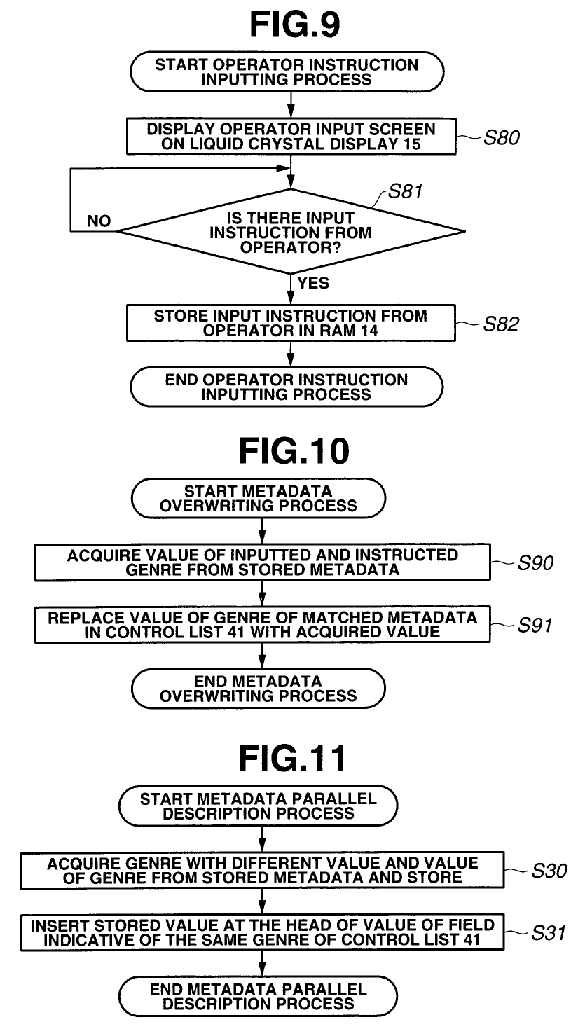

Meanwhile, if the values are different between the stored control list and the control list 41 as a result of the determination in step S73, an operator instruction inputting process shown in FIG. 9 is executed in step S74.

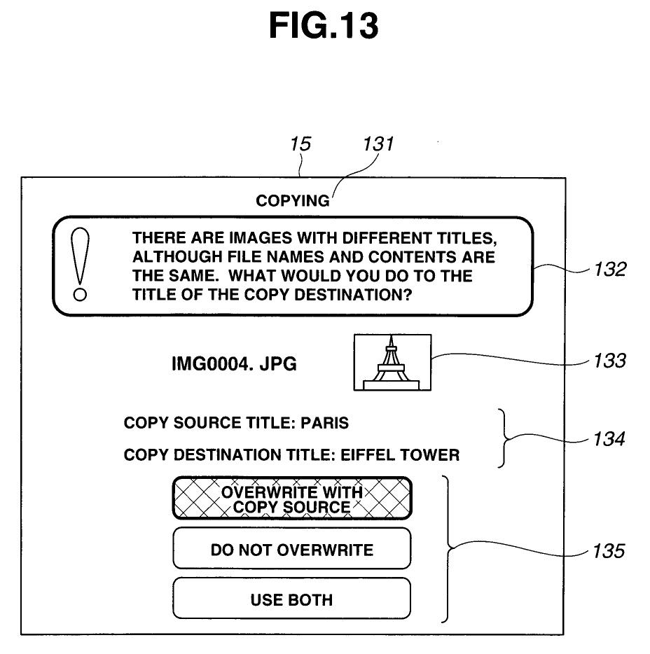

FIG. 9 is a flow chart of the operator instruction inputting process. In step S80 of the operator instruction inputting process, an operator input screen for prompting the operator to input an instruction is displayed on a predetermined location of the liquid crystal display 15 as shown in FIG. 13.

The operator input screen is constituted by a display 131 indicating that copying is underway, a display 132 indicating that there is content in which the file names of the copy source and the copy destination are the same but the metadata of a predetermined genre are different, a thumbnail (reduced image) display 133 of the content, a display 134 of the values of metadata that are different between the copy source and the copy destination, and an input icon display 135 indicative of choices of instruction.

The input icon display 135 is constituted by alternatively selectable three icons 135a, 135b, and 135c. The icons 135a, 135b, and 135c respectively correspond to instructions “OVERWRITE WITH METADATA OF COPY SOURCE”, “DO NOT OVERWRITE WITH METADATA OF COPY SOURCE”, and “USE BOTH METADATA”. The operator selects one of the icons 135a, 135b, and 135c on the operator input screen of the liquid crystal display 15 to provide an input instruction.

In step S81, whether there is an input instruction from the operator is determined, and the process waits for the input instruction. If there is an input instruction from the operator in step S81, the process proceeds to step S82 to store the input instruction from the operator in the RAM 14, and the operator input process is terminated.

In step S75, whether the input instruction from the operator stored in the RAM 14 is an instruction for overwriting with the metadata of the copy source, i.e. overwriting with the metadata of the external storing/reproducing device 30, is determined.

If the instruction for overwriting with the metadata of the copy source is inputted as a result of the determination in step S75, a metadata overwriting process shown in FIG. 10 is executed in step S76, and the metadata changing process is terminated.

If the instruction for not overwriting with the metadata of the copy source is inputted as a result of the determination in step S75, whether the input instruction from the operator is an instruction for using both metadata is determined in step S77.

If the instruction for using both metadata is inputted as a result of the determination in step S77, a metadata parallel description process shown in FIG. 11 is executed in step S78, and the metadata changing process is terminated. Meanwhile, if there is no instruction for using both metadata as a result of the determination in step S77, nothing is performed, and the metadata changing process is terminated.

FIG. 10 is a flow of the metadata overwriting process. In step S90 of the metadata overwriting process, a value of the genre inputted and instructed by the operator is acquired from the stored metadata. In step S91, a value of the genre inputted and instructed by the operator in the matched metadata of the content in the control list 41 is overwritten with the value acquired in step S90, and the metadata overwriting process is terminated.

FIG. 11 is a flow of the metadata parallel description process. In step S30 of the metadata parallel description process, the genre with a different value and the different value are acquired from the metadata stored in step S11, and the genre and the value are stored in the RAM 14. In step S31, the stored value is inserted at the head of the value of the field indicative of the same genre as the stored genre in the matched metadata of the content in the control list 41 using a predetermined delimiter.

An operation of the present embodiment will be described.

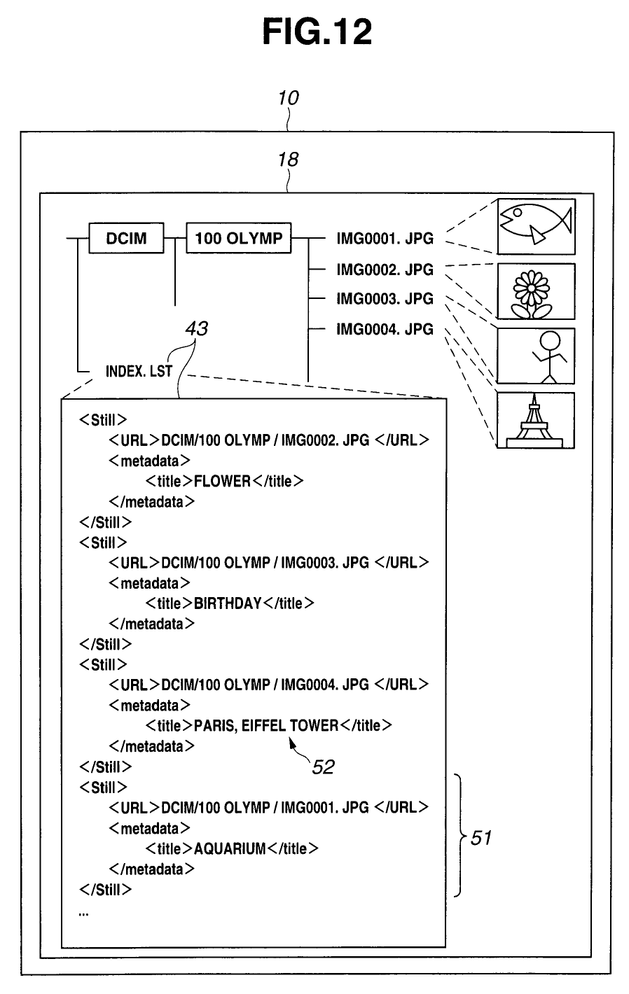

FIG. 12 depicts a result of the difference copying executed in accordance with the flows of FIGS. 6 to 11 in the external storing/reproducing device 30 and the DSC 10 in the states shown in FIGS. 4 and 5.

In the description below, it is assumed that the connection of the external storing/reproducing device 30 and the DSC 10 is already established (step S1) and that there is a difference copy instruction from the external storing/reproducing device 30 (step S2). It is also assumed that the operator inputs an instruction for using both metadata in the operator instruction inputting process of FIG. 9.

The DSC 10 first acquires the control list 42 of the external storing/reproducing device 30 through the external I/F 16 and stores the control list 42 in the RAM 14 (step S3).

The DSC 10 stores file paths “DCIM/100OLYMP/IMG0001.JPG”, “DCIM/100OLYMP/IMG0002.JPG”, “DCIM/100OLYMP/IMG0003.JPG”, and “DCIM/100OLYMP/IMG0004.JPG” described in the stored control list 42 in the RAM 14 (step S4).

The file path “DCIM/100OLYMP/IMG0001.JPG” is first compared with the file paths “DCIM/100OLYMP/IMG0002.JPG”, “DCIM/1000OLYMP/IMG0003.JPG”, and “DCIM/100OLYMP/IMG0004.JPG” of the content described in the control list 41 of the DSC 10 (step S5).

As a result of the comparison, the file path “DCIM/100OLYMP/IMG0001. JPG” described in the control list 42 does not match with the file paths of the content described in the control list 41 (step S6, NO). The content IMG0001.JPG indicated by the file path that does not match is acquired from the external storing/reproducing device 30 through the external I/F 16 and stored in the image storing section 18 (step S7).

The metadata <title>AQUARIUM</title> of the acquired IMG0001.JPG is acquired from the stored control list 42 (step S8), and a file type (still image=Still), the file path “DCIM/100OLYMP/IMG0001.JPG”, and the metadata <title>AQUARIUM</title> are added to the control list 41 (step S9). The result is shown as a description 51 in a control list 43 of the DSC 10 of FIG. 12.

As three file paths among the stored file paths are not yet compared (step S10, NO), and the file path “DCIM/100OLYMP/IMG0002.JPG” described next in the control list 42 is compared with the file paths described in the control list 41 (step S5). As a result, a matched file path is found (step S6, YES). Therefore, the metadata <title>FLOWER</title> is acquired from the stored control list 42, and the metadata is stored (step S11). The stored metadata matches with the metadata <title>FLOWER</title> of “DCIM/100OLYMP/IMG0002.JPG” in the control list 41 (step S12, YES).

As two file paths among the stored file paths are not yet compared (step S10, NO), the next file path “DCIM/100OLYMP/IMG0003.JPG” is compared with the file paths described in the control list 41 (step S5). As a result, a matched file path is found (step S6, YES).

Although the contents indicated by the file names of IMG0003.JPG are different between the external storing/reproducing device 30 and the DSC 10, the DSC 10, following the flow of FIGS. 6 and 7, does not acquire the contents. The metadata in the stored control list and the metadata in the control list 41 in relation to “DCIM/100OLYMP/IMG0003.JPG” are both <title>BIRTHDAY</title>. Therefore, the metadata match (steps S11 and S12, YES).

When the last file path “DCIM/100OLYMP/IMG0004.JPG” among the stored file paths is compared to the file paths described in the control list 41 (step S5), a matched file path is found (step S6, YES). The metadata of the control list 42 in relation to “DCIM/100OLYMP/IMG0004.JPG” is <title>PARIS</title>, while the metadata of the control list 41 is <title>EIFFEL TOWER</title>. Therefore, the metadata do not match (steps S11 and S112, NO). Thus, the metadata changing process is executed (step S13).

The field <title></title> indicative of the title as a genre is described in the stored metadata, and <title></title> indicative of the title as a genre is also described in the metadata of “DCIM/100OLYMP/IMG0004.JPG” of the control list 41 (step S71, NO). The value of the genre in the stored control list 42 is “PARIS”, while the value of the genre in the control list 41 is “EIFFEL TOWER”. Therefore, the values are different (step S73, YES).

The operator input screen shown in FIG. 13 is displayed on the liquid crystal display 15 (step S80), and the process waits for an input instruction from the operator (step S81). As there is an input instruction “use both metadata” from the operator, the content of the instruction (use both metadata) is stored in the RAM 14 (step S82).

Since the instruction from the operator is an instruction for using both metadata (step S75, NO, and step S77, YES), the metadata parallel description process is executed (step S78). As the genre with a different value is only the title among the stored metadata, the value PARIS is acquired and stored (step S30).

A delimiter “,” is inserted at the head of the value of the field <title></title> indicative of the title that is the same genre as the stored genre in the metadata of the content “DCIM/100OLYMP/IMG0004.JPG” in which the file path is matched in the control list 41 (step S31). As a result, the value of the field <title></title> indicative of the title in the control list 43 of the DSC 10 becomes “PARIS, EIFFEL TOWER” as in a description 52 in FIG. 12.

Consequently, the metadata parallel description process is terminated, and the metadata changing process is terminated. As comparisons of all four stored file paths are completed (step S10, YES), the control list 41 is saved (step S14), and the difference copying is terminated.

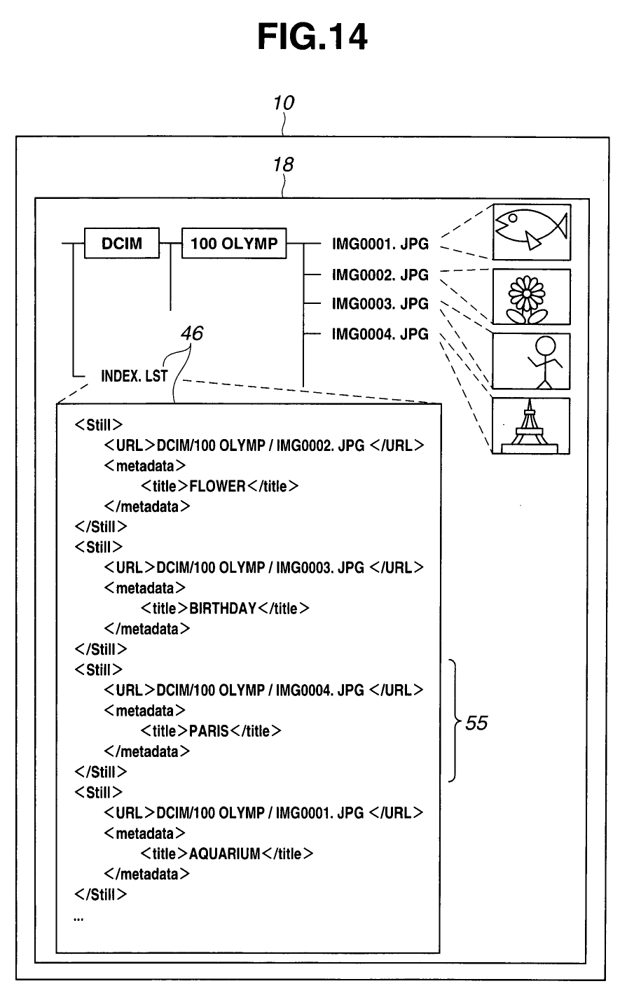

An operation in the case where the instruction received from the operator and stored in the RAM 14 in step S82 in the description of the operation of the embodiment above is an instruction for overwriting with the metadata of the copy source will be described as an example. The description up to the overwriting instruction (step S74) from the operator of “DCIM/100OLYMP/IMG0004.JPG” is the same as the description above, and therefore, the description will be omitted. Since there is an overwriting instruction from the operator, the instruction (overwriting instruction) is stored in the RAM 14 (step S82). As the instruction from the operator is an overwriting instruction (step S75, YES), the value PARIS of the genre of the title is acquired from the stored metadata (step S90). The value EIFFEL TOWER of the genre of the title is overwritten with the acquired value PARIS in the metadata of “DCIM/100OLYMP/IMG0004.JPG” in the control list 41 (step S91). The result is shown as a description 55 in the control list 46 of FIG. 14. Consequently, the metadata overwriting process is terminated, and the metadata changing process is further terminated. The following processes are the same as the description of the operation of the embodiment described above. Therefore, the description will be omitted.

Advantages of the present embodiment will be described.

As described above, the DSC 10 as an information processing apparatus of the present embodiment comprises: a difference copying section that acquires the content saved in the external storing/reproducing device 30 but not saved in the DSC from the external storing/reproducing device 30 based on the comparison result of the control lists 41 and 42 as content management information and that updates the control list 42; a comparison section that compares, for each genre, metadata of the second content described in the control list 42 of the external storing/reproducing device 30 and the metadata of the first content that is the same as the second content and that is described in the control list 41 of the DSC 10; an instruction inputting section that displays an operator input screen on the liquid crystal display 15 in accordance with the result of the comparison section and that receives an input related to the process of the metadata from the operator; and a metadata changing section that changes the metadata.

Having such a configuration, upon the difference copy process with the external storing/reproducing device 30, the DSC 10 as an information processing apparatus of the present embodiment can ask the operator how to handle the metadata when contents with the same names and the same contents exist both in the external storing device 30 as a copy source and in the DSC 10 as a copy destination and the metadata of the contents are different, and can change the metadata based on the instruction from the operator. Thus, in the present embodiment, the operator's intention can be reflected upon copying of the content because an instruction for the process related to the metadata of the content in the control list of the copy destination is always provided by the operator. Therefore, according to the present embodiment, the metadata is not overwritten or deleted without the operator recognizing it, and the metadata is not overwritten or deleted contrary to the intention of the operator.

Obviously, various modification and changes can be made to the configurations of the present embodiment. A modified example of the present embodiment will be described below.

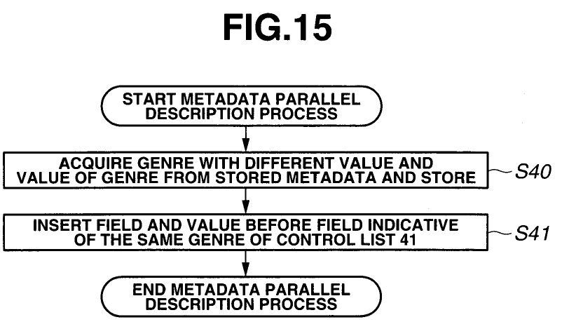

FIG. 15 depicts a modified example of the metadata parallel description process of step S24. In step S40 of the present modified example, a genre with a different value and the different value are acquired from the metadata stored in step S11, and the RAM 14 stores the genre and the value. In step S41, the field and the value are inserted before the field indicative of the stored genre in the matched metadata of the content in the control list 41.

An operation of the present modified example will be described.

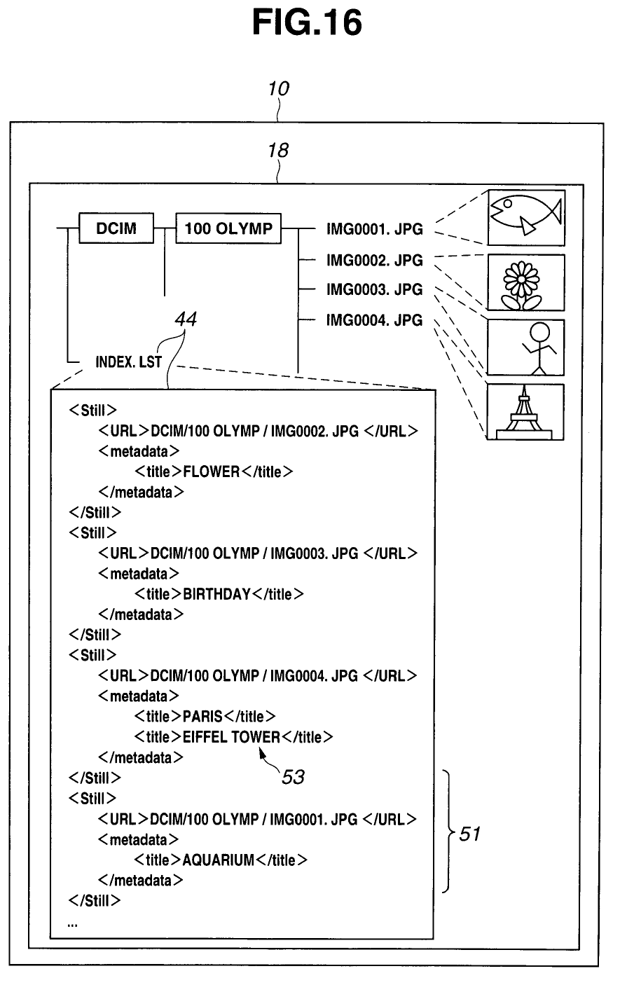

FIG. 16 depicts a result of the difference copying executed in accordance with the flows of FIGS. 6 to 10 and FIG. 15 of the present modified example in the external storing/reproducing device 30 and the DSC 10 in the states of FIGS. 4 and 5. Since the genre with a different value among the stored metadata is only the title in relation to “DCIM/100OLYMP/IMG0004.JPG”, the value “PARIS” is acquired and stored (step S40). The field <title></title> and the value “PARIS” are inserted before the field <title></title> indicative of the title as a genre that is the same as the stored genre in the metadata of the content “DCIM/100OLYMP/IMG0004.JPG” in which the file path is matched in the control list 41 (step S41). The result is shown as a description 53 in a control list 44 of the DSC 10 of FIG. 16.

An advantage of the modified example of the present embodiment will be described.

As described, the DSC 10 as an information processing apparatus of the present modified example includes a metadata listing section that lists and describes fields indicative of the types of metadata when storing both of different metadata attached to the same contents stored in both of the DSC 10 and the external storing/reproducing device 30 and that describes one metadata as a value to each field.

In the DSC 10 as an information processing apparatus of the present modified example having such a configuration, the values of the metadata are described as a factor in the control list 42 when the metadata is described in parallel. Therefore, according to the present modified example, the analysis of the control list is facilitated, and the operator can easily handle the control list.

Another modified example of the present embodiment will be described.

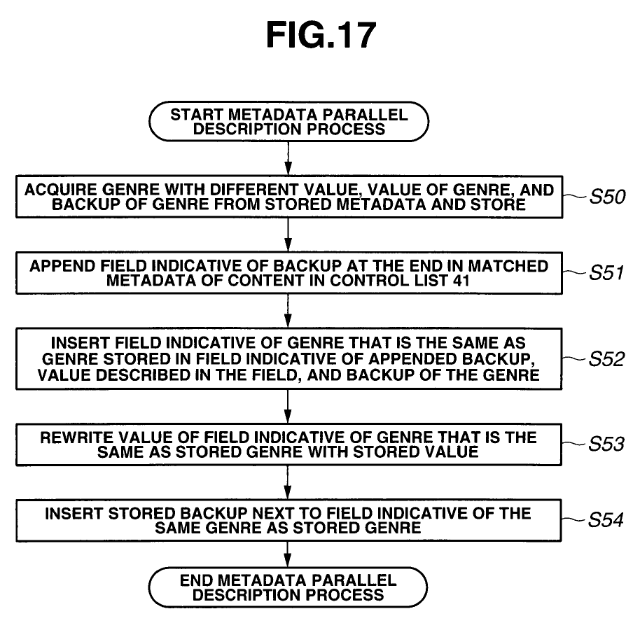

FIG. 17 is a flow chart of another modified example of the metadata parallel description process of step S24. In step S50, a genre with a different value, the different value, and the content described as a backup of the genre are acquired from the metadata stored in step S11, and the RAM 14 stores the genre, the value, and the content.

In step S51, the field indicative of the backup is appended at the end of the field indicative of the stored genre in the matched metadata of the content in the control list 41. In step S52, the field indicative of the genre that is the same as the stored genre, the value described in the field, and the content described as a backup of the genre are inserted in the field indicative of the backup appended in step S51.

In step S53, the value of the field indicative of the same genre as the stored genre is rewritten with the stored value. In step S54, the backup stored in step S50 is inserted next to the field indicative of the same genre as the stored genre.

An operation of the another modified example of the present embodiment will be described.

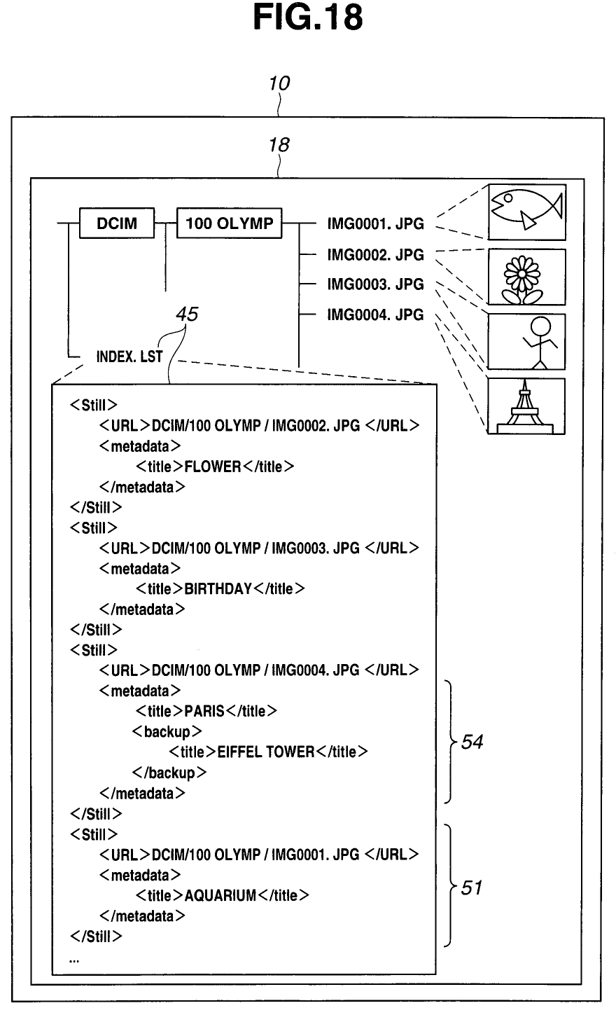

FIG. 18 depicts a result of the difference copying executed in accordance with the flows of FIGS. 6 to 10 and FIG. 17 of the present modified example in the external storing/reproducing device 30 and the DSC 10 in the states of FIGS. 4 and 5. Since the genre with a different value among the stored metadata is only the title in relation to “DCIM/100OLYMP/IMG0004.JPG”, the value “PARIS” is acquired and stored (step S50). The backup of the title is not stored as the backup does not exist.

The field <backup></backup> indicative of the backup in the metadata of the content “DCIM/100OLYMP/IMG0004.JPG” in which the file path is matched in the control list 41 is appended at the end (step S51). The field indicative of the genre that is the same as the title as a stored genre and the value “EIFFEL TOWER”, i.e. <title>EIFFEL TOWER</title>, described in the field is inserted in the field indicative of the backup (step S52).

The backup of the title is not inserted as the backup does not exist. The field indicative of the genre that is the same as the title as a stored genre is rewritten with the stored value PARIS (step S53). The stored backup is not inserted as the backup does not exist (step S54). The result is shown as a description 54 in a control list 45 of the DSC 10 of FIG. 18.

An advantage of the another modified example of the present embodiment will be described.

As described, the DSC 10 as an information processing apparatus of the present modified example includes a metadata backup section that describes the metadata related to the first content in the control list 41 of the DSC 10 as a backup in the control list 41 when storing both of different metadata attached to the same contents stored in both of the DSC 10 and the external storing/reproducing device 30 and that replaces the metadata related to the first content in the control list 41 with the metadata related to the second content in the control list 42 of the external storing/reproducing device 30 before describing the metadata.

The DSC 10 as an information processing apparatus of the present modified example having such a configuration can handle the metadata other than the latest metadata not as the latest metadata but as a backup when the metadata is described in parallel. Therefore, according to the present modified example, the history of the changes of the metadata can be easily checked, and a recovery process or the like for restoring the metadata can be executed.

Still another modified example of the present embodiment will be described.

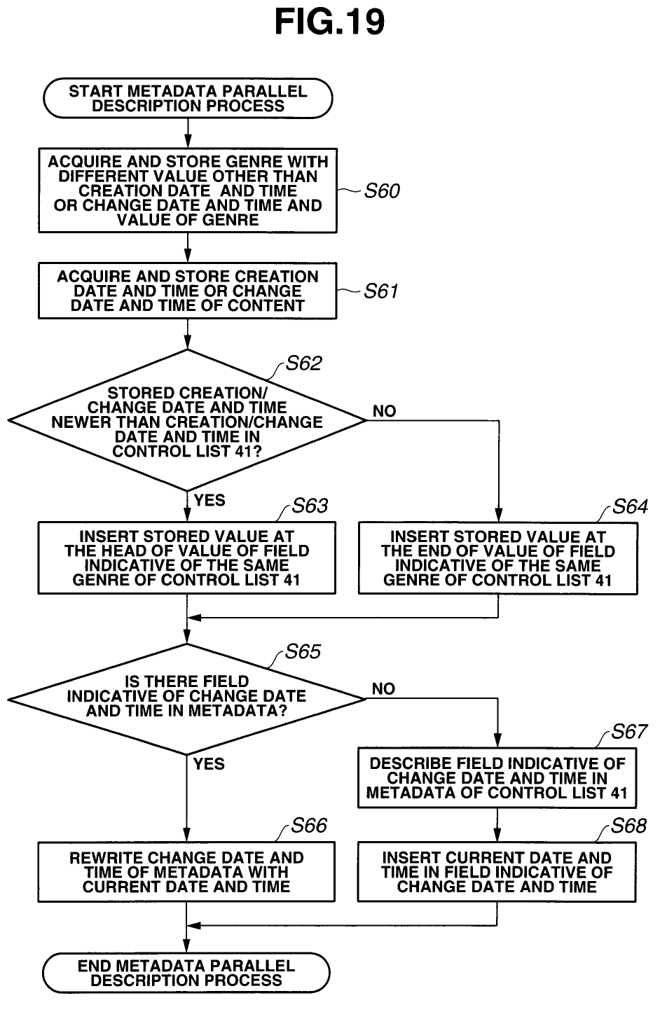

FIG. 19 is a flow chart of still another modified example of the metadata parallel description process of step S24. In step S60, a genre other than the creation date and time or the change date and time with a different value and the different value are acquired from the metadata stored in step S11, and the RAM 14 stores the genre and the value. In step S61, a value of the field indicative of the creation date and time or the change date and time of the content is acquired from the stored metadata, and the RAM 14 stores the value.

In step S62, whether the creation date and time or the change date and time stored in step S61 is newer than the creation date and time or the change date and time described in the matched metadata of the content in the control list 41 is determined. If the stored creation date and time or the change date and time is newer as a result of the determination, a predetermined delimiter is used and the stored value is inserted at the head of the value of the field indicative of the genre that is the same as the stored genre in the matched metadata of the content in the control list 41 in step S63. If the creation date and time or the change date and time described in the matched metadata of the content in the control list 41 is newer as a result of the determination of step S62, a predetermined delimiter is used and the stored value is inserted at the end of the field indicative of the genre that is the same as the stored genre in the matched metadata of the content in the control list 41 in step S64.

After steps S63 and S64, whether a field indicative of the change date and time is described in the matched metadata in the control list 41 is determined in step S65. If the field indicative of the change date and time is described as a result of the determination, the value of the change date and time described in the matched metadata of the content in the control list 41 is rewritten with the current date and time in step S66, and the metadata changing process is terminated. If the field indicative of the change date and time is not described as a result of the determination of step S65, the field indicative of the change date and time is described in the matched metadata of the content in the control list 41 in step S67. In step 68, the current date and time is inserted to the field indicative of the change date and time described in step S67, and the metadata parallel description process is terminated.

An operation of the still another modified example of the present embodiment will be described.

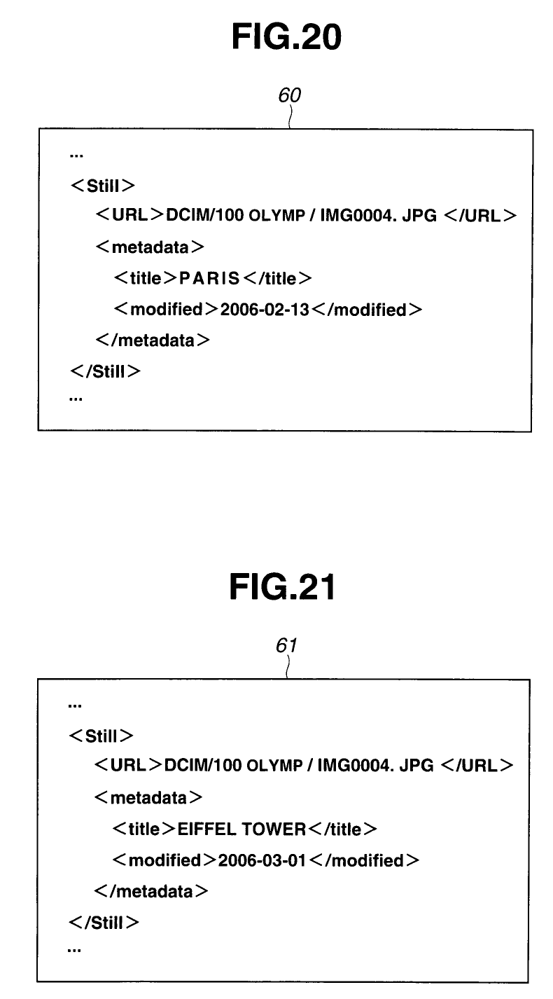

FIG. 20 is an example of a control list 60 stored in the storing section 31 of the external storing/reproducing device 30. FIG. 21 is an example of a control list 61 stored in the image storing section 18 of the DSC 10. Although both control lists describe the content “DCIM/100OLYMP/IMG0004.JPG”, in the control list 60, the title of the content is “PARIS”, the change date and time is described in the field <modified></modified>, and the change date and time is “2006-02-13”. Meanwhile, in the control list 61, the title is “EIFFEL TOWER”, and the change date and time is “2006-03-01”.

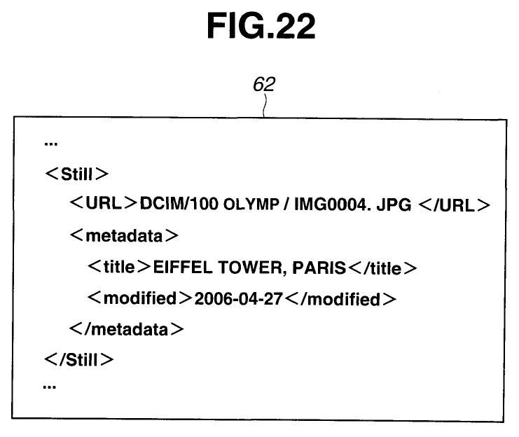

FIG. 22 depicts a result when the flow of FIG. 19 is followed in the states of FIGS. 20 and 21. The value “PARIS” is acquired and stored because the genre other than the creation date and time or the change date and time with a different value in the stored metadata in relation to “DCIM/100OLYMP/IMG0004.JPG” is only the title (step S60).

As for the creation date and time or the change date and time of the stored metadata, the change date and time is indicated by the field <modified></modified>, and the value is “2006-02-13 (i.e. Feb. 13, 2006)”. Therefore, the value is acquired and stored in the RAM 14 (step S61).

The creation date and time or the change date and time described in the matched metadata of the content in the control list 61 is “2006-03-01 (i.e. Mar. 1, 2006)” (step S62). Therefore, a delimiter “,” is used and the stored value “PARIS” is inserted at the end of the field <title></title> indicative of the title in the metadata of “DCIM/100OLYMP/IMG0004.JPG” in the control list 61 (step S64).

The field <modified></modified> indicative of the change date and time is described in the metadata “DCIM/100OLYMP/IMG0004.JPG” in the control list 61 (step S65). Therefore, the value “2006-03-01” described in the change date and time of “DCIM/100OLYMP/IMG0004.JPG” of the control list 61 is rewritten with the current date and time (for example, “2006-04-27” in case of Apr. 27, 2006) (step S66), and the metadata parallel description process is terminated. The result is as described in the control list 62 of the DSC 10 of FIG. 22.

An advantage of the still another modified example of the present embodiment will be described.

As described, the DSC 10 as an information processing apparatus of the present modified example is configured to describe the metadata to be described in parallel in descending order or in ascending order based on the date and time information acquired from the metadata indicative of the creation date and time or the update date and time describing the contents when storing both of the different metadata attached to the same contents stored in both of the DSC 10 and the external storing/reproducing device 30.

In the DSC 10 as an information processing apparatus of the present modified example having such a configuration, the metadata is lined up by date when the metadata is described in parallel. Therefore, the operator can easily figure out the metadata and find the targeted metadata when the metadata are displayed.

The information processing apparatus described in the above embodiment is not limited to the digital still camera. The information processing apparatus may be a device capable of storing and reproducing digital content, such as a cellular phone, a PDA, a personal computer, a gaming machine, a digital video camera, a digital music player, a printer, an optical disk recorder such as a DVD, a TV, binoculars, and photo storage. Furthermore, the digital content is not limited to the still images. Various modifications, such as motion pictures, music, documents, drawings, save data of a game, play lists of music or motion pictures, and an address book can be made. Although the above embodiment has been described using a structure called XML as a description format of the control list, the description format of the control list is not limited to XML as long as the description format is formed of a structure capable of expressing the file paths of the content and the metadata.

The present invention is not limited to the above embodiment. Appropriate modifications can be made without departing from the spirit and scope of the present invention that can be interpreted from the claims and the entire specification. Such modified information processing apparatus, information processing method, and the program storage medium storing the program are also included in the technical scope of the present invention.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An information processing apparatus that replicates and stores content data stored in an external device, the information processing apparatus comprising:
a content data storing section that stores first content data;
a metadata storing section that stores first metadata related to the first content data;
a content data detecting section that detects whether second content data that is the same content data as the first content data is stored in the external device;
a comparison section that compares second metadata related to the second content data stored in the external device and the first metadata when the content data detecting section detects that the second content data is stored in the external device;
an instruction inputting section that causes an operator to input an instruction related to a changing process of the first metadata when the first metadata and the second metadata are different based on a comparison result of the comparison section; and
a metadata changing section that changes the first metadata based on the instruction of the operator inputted through the instruction inputting section.

2. The information processing apparatus according to claim 1, wherein
the content data detecting section detects whether the second content data exists by comparing first content management information for managing content data stored in the content data storing section and second content management information for managing content data stored in the external device.

3. The information processing apparatus according to claim 2, wherein
the first content management information is a control list for performing at least one of storing and reproducing the first content data in the information processing apparatus, and
the second content management information is a control list for performing at least one of storing and reproducing the second content data in the external device.

4. The information processing apparatus according to claim 3, wherein
the first metadata is stored in the control list of the information processing apparatus, and
the second metadata is stored in the control list of the external device.

5. The information processing apparatus according to claim 1, wherein
the metadata changing section overwrites the first metadata with the second metadata or adds the second metadata to the first metadata based on the instruction of the operator.

6. The information processing apparatus according to claim 1, wherein
the instruction inputting section comprises:
a display section that displays the first metadata and the second metadata when the comparison section detects that the first metadata and the second metadata are different; and
a selecting section that causes an operator to select and input a method of the changing process of the first metadata.

7. An information processing method of replicating and storing content data stored in an external device in an information processing apparatus, the information processing method comprising:
storing first content data and first metadata related to the first content data in the information processing apparatus;
detecting whether second content data that is the same as the first content data is stored in the external device;
comparing the first metadata and second metadata related to the second content data stored in the external device when the second content data is detected;
prompting an operator to input an instruction related to a changing process of the first metadata when the first metadata and the second metadata are different; and
changing the first metadata based on the inputted instruction of the operator.

8. The information processing method according to claim 7, wherein
the detecting of the second content data is performed by comparing first content management information for managing content data stored in the information processing apparatus and second content management information for managing content data stored in the external device.

9. The information processing method according to claim 7, wherein
the changing of the first metadata is a process of overwriting the first metadata with the second metadata or a process of adding the second metadata to the first metadata.

10. The information processing method according to claim 7, wherein
the first metadata and the second metadata are displayed and choices for the operator to select a method of the changing process of the first metadata are displayed when the first metadata and the second metadata are detected to be different.

11. A program storage medium storing a program for replicating and storing content data stored in an external device in a computer, the program comprising:
a step of storing first content data and first metadata related to the first content data in the computer;
a step of detecting whether second content data that is the same as the first content data is stored in the external device;
a step of comparing the first metadata and the second metadata related to the second content data stored in the external device when the second content data is detected;
a step of prompting an operator to input an instruction related to a changing process of the first metadata when the first metadata and the second metadata are different; and
a step of changing the first metadata based on the inputted instruction of the operator.

12. The program storage medium storing the program according to claim 11, wherein
the program comprises:
a step of detecting the second content data by comparing first content management information for managing content data stored in the information processing apparatus and second content management information for managing content data stored in the external device.

13. The program storage medium storing the program according to claim 12, wherein
the program comprises:
a step of executing at least one of storing and reproducing the first content data in the information processing apparatus based on the first content management information.

14. The program storage medium storing the program according to claim 13, wherein
the program comprises:
a step of describing the first metadata in the first content management information.

15. The program storage medium storing the program according to claim 11, wherein
the program comprises:
a step of executing a process of overwriting the first metadata with the second metadata or a process of adding the second metadata to the first metadata based on the instruction of the operator.

16. The program storage medium storing the program according to claim 11, wherein
the program comprises:
a step of displaying the first metadata and the second metadata when the first metadata and the second metadata are detected to be different as a result of the comparison; and
a step of displaying choices for the operator to select a method of the process of changing the first metadata.
